(19) United States
(12) Patent Application Publication
(10) Pub. No.: US 2006/0171824 A1
(43) Pub. Date: Aug. 3, 2006

(54) Compressor connecting rod bearing design

(75) Inventors: Jeffrey J. Nieter, Coventry, CT (US); Ulf J. Jonsson, South Windsor, CT (US); Tobias H. Sienel, East Hampton, MA (US)

Correspondence Address: CARLSON, GASKEY & OLDS, P.C., 400 WEST MAPLE ROAD, SUITE 350, BIRMINGHAM, MI, 48009, US

(73) Assignee: Carrier Corporation

(21) Appl. No.: 11/045,194

(22) Filed: Jan. 28, 2005

(51) Int. Cl. F02F 7/00; F04B 35/04; F16C 11/00

(52) U.S. Cl. 417/415; 92/261; 74/605

(57) ABSTRACT

An improvement to the oil supply grooves in connecting rods for compressors increases surface area in an upper bearing half. The upper bearing half transmits a force from a driveshaft to the connecting rod. The lower half of the connecting rod includes an oil supply groove that extends over the majority of a circumferential extent of a bearing surface in the lower half that contacts an eccentric. On the other hand, the inner surface of the upper half does not include any large oil supply groove such that the surface area between the upper half and the eccentric is maximized.

### BACKGROUND OF THE INVENTION

This invention relates to an improved compressor connecting rod design for providing maximum surface area in the “big-end” bearing for transmitting an actuation force to the piston while allowing for pressurized lubrication of the “small-end” or wrist pin bearing.

Compressors are utilized in many applications to compress various fluids. One type of compressor is a reciprocating piston compressor. In a reciprocating piston compressor, a driveshaft rotates at least one eccentric. Each eccentric in turn drives a connecting rod that is connected to a piston by a wrist pin. The connecting rod has a “big-end” bearing that is typically received on the eccentric. An opposed end of the connecting rod has a “small-end” bearing that is typically received on a wrist pin that is in turn received in the piston.

A good deal of friction is encountered in these connecting rod bearings from transmitting the force of actuation to the piston. Thus, it is known in the art to provide lubricant to the various moving surfaces in a compressor to facilitate the movement of the piston and the connecting rod. Typically, a lubricant is driven into a lubricant path inside the driveshaft where it is distributed to the feedholes for each eccentric and the main bearings. This lubricant may also be communicated up through the connecting rod to the “small-end” bearing to lubricate the wrist pin and corresponding bearing in the piston.

A common configuration of the connecting rod is one formed by an upper half and a lower half that are brought together and then bolted or otherwise secured to the eccentric to provide the big-end bearing. The prior art has utilized two main types of geometry in this big-end bearing. In the first type, there is no oil groove in the bearing surface. In the second type, there is an oil groove around the full 360 degree inner periphery of the bearing surface. In conjunction with these bearing designs, it is common to provide an oil lubrication passage that extends up through the connecting rod to the small-end bearing. In the first type of big-end bearing, this prior art has sometimes not provided adequate lubrication to the small-end bearing surfaces. In the second type of big-end bearing design, more adequate oil flow is provided to lubricate the small-end bearing.

Often, these big-end bearing configurations are utilized in a connecting rod having a “shell bearing” inserted into the big-end bore. While the second big-end bearing design provides more adequate lubrication flow, it has its own deficiencies. In particular, the inner periphery of the upper half of the bearing surface is a force transmission surface for transmitting the force from the eccentric to the connecting rod. The oil groove in this surface reduces the area available to support an oil film and results in reduced film thickness that may be too thin to separate the bearing and eccentric surfaces.

It would be desirable to address the deficiencies in the prior art as mentioned above.

### SUMMARY OF THE INVENTION

In a disclosed embodiment of this invention, a connecting rod has a big-end bearing with an oil supply groove over at least a majority of its lower half, and little or no oil supply groove in its upper half. In this manner, oil is still adequately supplied up through the connecting rod to the small-end bearing surfaces while the big-end bearing surface for force transmission is still maximized.

In one embodiment, which does not use shell bearings, the groove is formed across the entire circumferential extent of the big-end bearing surface of the lower half. This groove communicates lubricant to a passage extending through the upper half. The passage does not communicate with the inner periphery of the big-end bearing surface of the upper half. Thus, the bearing surface area is maximized in the upper half.

In another embodiment, and one which does use shell bearings, extreme circumferential ends of the bearing shells have passages for allowing the lubricant to flow into a groove formed radially outwardly of the shells. This groove communicates with a passage extending up through the connecting rod to the small-end bearing.

These and other features of the present invention can be best understood from the following specification and drawings, the following of which is a brief description.

### BRIEF DESCRIPTION OF THE DRAWINGS

FIG. 1 shows a prior art compressor.

FIG. 2A shows one prior art embodiment.

FIG. 2B shows another prior art embodiment.

FIG. 3 shows a first embodiment.

FIG. 4 is a sectional view through a portion of the FIG. 3 embodiment.

FIG. 5 shows a lower bearing portion of the first embodiment.

FIG. 6 shows a second embodiment.

FIG. 7 is a cross-sectional view through the FIG. 6 embodiment.

### DETAILED DESCRIPTION OF THE PREFERRED EMBODIMENT

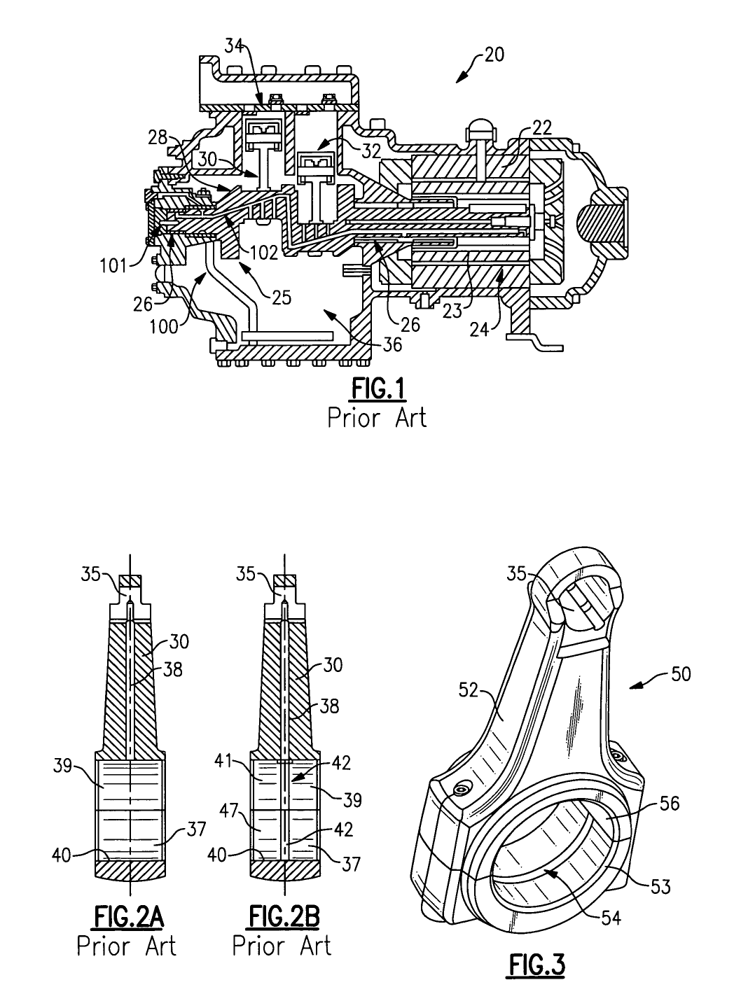

A prior art compressor 20 is illustrated in FIG. 1 having a motor 22 including a stator 24. Stator 24 causes a rotor 23 to rotate and drive a driveshaft 25. As shown, ends 26 of the driveshaft 25 are mounted in bearings. Eccentrics 28 on the driveshaft drive connecting rods 30. Connecting rods 30 have a “big-end” received on each eccentric 28, and a “small-end” received in pistons 32. Pistons 32 move towards and away from a valve plate 34 to compress a refrigerant. An oil sump 36 delivers oil through passages 100 to an oil pump 101, and to a passage 102 extending through the shaft 25.

As shown in FIG. 2A, in one prior art embodiment, some of this oil moves through the connecting rod 30 by being drawn into a passage 38. The connecting rod 30 is formed from a lower half 37 and an upper half 39. The two halves 37 and 39 are bolted together on the eccentric 28, as known. An inner periphery bearing surface 40 of the two halves 37 and 39 does not include any oil groove. Rather, oil which leaves the passage 102 will migrate into the passage 38 and move upwardly toward the small-end bearing 35, to in turn lubricate the wrist pin bearing surfaces.

FIG. 2B shows another prior art embodiment wherein shell bearing halves 41 are placed within both the lower and upper halves 37 and 39. A groove 42 is formed in both of the shell bearing halves 41, and communicates with the passage 38 through at least one opening in the shell bearing 41 on the upper half 39.

Generally, the FIG. 2A embodiment does not always supply adequate lubricant and the FIG. 2B embodiment has the problem of reducing the available surface area at the bearing surface 40 of the upper half 39. It is this surface that receives the transmitted force from the eccentric 28 to drive the connecting rod 30 and piston 32 toward the valve plate 34. A reduction of the surface area due to the groove 42 is undesirable and reduces the oil film thickness needed to separate the bearing surface 40 from the eccentric 28.

FIG. 3 shows a connecting rod embodiment 50 that is inventive. An upper half 52 is formed within an inner peripheral bearing surface 56 that does not include any oil groove. A lower half 53 does include a groove 54 extending throughout its circumferential extent.

As shown in FIG. 4, an opening 58 at a lower end of the upper half 52 of the connecting rod 50 receives lubricant from an end of the groove 54. End 58 communicates this lubricant to the passage 57 extending upwardly toward the small-end 35 of the connecting rod 50.

As mentioned, the inner periphery 55 of the lower half 53 includes the groove 54. This is also better shown in FIG. 5, which also shows a communicating opening 59 in the lower half 53 which will communicate the lubricant to the opening 58. The first embodiment thus provides adequate lubricant flow to the small-end 35 of connecting rod 50, but also maximizes the surface area at the inner periphery 56 of the upper half 52.

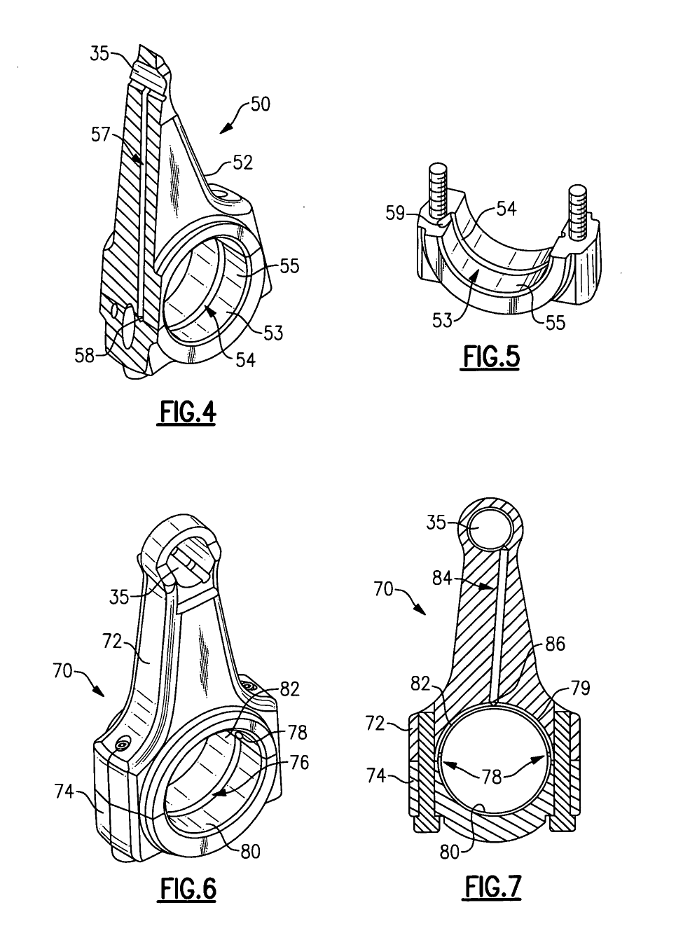

FIG. 6 shows another embodiment 70, with upper half 72 of the connecting rod 70 secured to the lower half 74 as in the above embodiment. A groove 76 is again formed in the shell bearing 80 of the lower half 74. Openings 78 are formed at the extreme ends of the shell bearing 82 mounted within the upper half 72.

As shown in FIG. 7, the small openings 78 extending through the shell bearing 82 on the upper half 72 communicate with a groove 79 formed in the nominal body of the upper half 72. Groove 79 communicates with an opening 86 that in turn communicates with the passage 84 extending to the small end 35 of the connecting rod 70. While some small amount of surface area is lost due to the openings 78, the openings are preferably positioned at the circumferential extremes of the upper half 72, and thus not directly in the force transfer direction. Moreover, the openings 78 still result in an increase in surface area for the force transmission when compared to the prior art.

While the present invention can be utilized in compressors to compress a variety of fluids, it is particularly adapted to a refrigerant compressor, and in particular a compressor to compress CO₂ to be used as a refrigerant.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A compressor comprising:
a motor operable to drive a rotating shaft, said rotating shaft driving at least one eccentric;
a connecting rod connected at a first bearing surface around said eccentric, said first bearing surface including a lower connecting rod half and an upper connecting rod half, said upper connecting rod half extending to a second bearing surface around a wrist pin, said wrist pin connected to a piston;
said piston being movable within a cylinder to compress a fluid;
an oil supply system for supplying oil to said connecting rod through said shaft; and
an oil groove formed in at least the majority of a circumferential extent of an inner surface of said lower connecting rod half that surrounds said eccentric, and no oil groove being formed in the majority of a circumferential extent of an inner surface of said upper connecting rod half that surrounds said eccentric, and a passage extending through said upper connecting rod half to deliver lubricant to said second bearing surface that surrounds said wrist pin connected to said piston.

2. The compressor as set forth in claim 1, wherein there are a plurality of said eccentrics, a plurality of said connecting rods, a plurality of said wrist pins, and a plurality of said pistons driven by said rotating shaft.

3. The compressor as set forth in claim 1, wherein said upper connecting rod half and said lower connecting rod half are bolted together.

4. The compressor as set forth in claim 1, wherein said oil groove in said inner surface of said lower connecting rod half communicating lubricant to an opening, said opening communicating lubricant into said passage through said upper connecting rod half.

5. The compressor as set forth in claim 4, wherein said passage through said upper connecting rod half is formed to one side of said inner surface of said upper connecting rod half such that said passage does not extend into said inner surface.

6. The compressor as set forth in claim 1, wherein said upper connecting rod half receives a bearing insert.

7. The compressor as set forth in claim 6, wherein said lower connecting rod half also receives a bearing insert to define said inner surface, said bearing insert in said lower connecting rod half including said oil groove extending circumferentially.

8. The compressor as set forth in claim 6, wherein an oil groove is formed in said upper connecting rod half radially outwardly of said bearing insert.

9. The compressor as set forth in claim 8, wherein oil supply openings are formed through said bearing insert in said upper connecting rod half at small circumferentially spaced locations.

10. The compressor as set forth in claim 9, wherein said small openings are formed at extreme circumferential ends of said bearing insert.

11. The compressor as set forth in claim 1, wherein the working fluid is CO₂.
